(19) United States
(12) Patent Application Publication
(10) Pub. No.: US 2019/0216065 A1
(43) Pub. Date: Jul. 18, 2019

(54) Method for Affixing Attachments to an Artificial Lure

(71) Applicants: Michal Peichl, Houston, TX (US); Shelby LaCroix, Houston, TX (US)

(72) Inventors: Michal Peichl, Houston, TX (US); Shelby LaCroix, Houston, TX (US)

(21) Appl. No.: 16/246,485

(22) Filed: Jan. 12, 2019

Related U.S. Application Data
(60) Provisional application No. 62/616,725, filed on Jan. 12, 2018.

(51) Int. Cl. A01K 83/06

(52) U.S. Cl. CPC A01K 83/06

(57) ABSTRACT

The present invention discloses a device and method for expeditious, efficient and uncomplicated artificial lure and live bait augmentation through filamentous strand or strands attachment in the form of a “tag” that allows for prepopulated or “in-field designed”, angler-specific and angler self-populated adherence of one or a plurality of attachments designed to enhance artificial lure or live bait characteristics in relation to visual recognition, sonic profile, reflectivity, color, hook or hooks display, laminar-turbulent footprints, and weight and buoyancy functioning features.

### CROSS-REFERENCE TO RELATED APPLICATIONS

This application claims priority to U.S. Provisional Patent Application No. 62/616,725, filed Jan. 12, 2018

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### SPECIFICATION

### Field of the Invention

The present invention relates to a method of artificial lure and live bait modification and augmentation through attachment of various forms of visual enhancing, sound-generating and weight and buoyancy providing accessories, generally, and to a method that incorporates an injection “gun” that inserts a readily customizable or a pre-loaded, filamentous “tag” in the form of an externally residing strand that is made to be attached to the body of an artificial fishing lure or live bait through a precise point of insertion for accessory attachment, specifically.

### Background of the Invention

Commercial and recreational fishing have long been associated with various weight and hook arrangements, in conjunction with artificial lures and live bait, in an attempt to increase both the odds of catching fish and the number of fish that that increase brings. And while line attachment of live-bait has had moderate innovations, the artificial lure market is chalk-full of all modes of lure, weight and hook arrangements that are designed and configured to provide an enhanced ‘catch’, whether for pleasure or profit. Yet, commercially available lures obtainable on the open market all suffer the same infirmity—an inability to undergo a post-sale and “in-field” augmentation that is both easily customizable and environment and angler-specific. Clearly, artificial lures are, for the most part, either immutable or changeable in only a predetermined and predefined manner.

Artificial lures throughout the years have undergone changes in shape, color, visual recognition, reflectivity, audible sound projection, and weight and buoyancy conformations—all in hopes of increasing the success of the angler. The artificial lure, though, while variable, is only changeable to a certain measure or degree. This rigidity of form, and resulting static function, is a dilemma long-faced in the artificial lure arena. And, while several attempts have been made to aid in the convertibility of a fishing lures' configuration, appearance and the ability to generate sound, none yet have the ability to achieve all mutations contemporaneously.

Clearly, much attention has been paid to the predefined configuration and reconfiguration of form of a fishing lure in an attempt to provide the fisherman a means to adjust a lure “in the field” in response to changing conditions and varying number and type of prey fish desired. To this end, Dougherty (U.S. Pat. No. 4,807,387) Briccetti (U.S. Application Number US 2011/0010983A1), Gibbs (U.S. Pat. No. 5,381,620), and Boucher (U.S. Pat. No. 5,953,849), among others, have sought to change the physical features of an artificial lure through replaceable features. Each though seek to achieve such mutation through set cumbersome and time-consuming endeavors. Likewise, Toris (U.S. Pat. No. 6,606,815), Pacora (U.S. Pat. No. 5,678,349) and Rinaldi (U.S. Pat. No. 4,941,280) have pursued an artificial fishing lure exhibiting a changing color profile through equally arduous means that requires not only excessive manipulation, but also a protracted time period for augmentation that wastes valued and valuable time.

Attempts, too, have been made to attract and catch fish through changes in visual recognition by Marusak (U.S. Pat. No. 6,058,643), Stevens (U.S. Pat. No. 3,877,168), and Ravencroft (U.S. Pat. No. 6,155,000), reflectivity (U.S. Pat. No. 5,678,350 issued to Moore), sound (See U.S. Pat. No. 4,805,339 Fuentes, U.S. Pat. No. 3,908,298 issue to Strader, and U.S. Pat. No. 5,201,784 issued to McWilliams), and hook placement (See U.S. Pat. No. 4,334,381 issued to Carver, U.S. Pat. No. 4,791,749 issued to Stazo, and U.S. Pat. No. 3,611,614 issued to Ward). Yet, as with the other aforementioned transmutations, these changes are alterations that are limited to a very small subset of options that themselves cannot move beyond a predetermined set of selections.

Moreover, angler's over time have struggled with the often-realized dilemma of weight distribution and the opposing forces of buoyancy—another aspect of “free-form” mutability the present invention strives to solve. It has long been recognized that weight, weight distribution and buoyancy aiding chambers (utilizing, in the greatest number of artificial lures, air) have the largest influence on the characteristics and movements of the lure through water. Efforts have been made to (1) distribute weight (See U.S. Pat. No. 3,555,717 issued to Gautsche and U.S. Pat. No. 5,490,347 issued to Conley), (2) configure weights (See U.S. Pat. No. 3,500,576 issued to Ostrom), (3) internalize weight (See U.S. Pat. Nos. 5,134,799, 6,912,808, and 5,822,912 issued to Trnka, Mak, and Kato, et. al respectively), (4) externalize weight (See U.S. Pat. No. 7,322,150 issued to Kent and U.S. Pat. No. 4,653,212 issued to Pixton) and (5) even adjust the size and mass of the weight as described by Ostrom in U.S. Pat. No. 3,500,576 where the '576 patent states “the weight is replaceable and removable [where] one lure may be provided with a plurality of different size weights which will permit the fisherman to purchase a single lure along with a plurality of different size weights rather than purchasing complete lures of different weights”. Equally, in opposition to the means to facilitate the weight or “sinking” of the lure, endeavors have been made to enhance the buoyancy, or upward thrust, exerted by the displaced liquid (i.e. water). Specifically, in Spivey (U.S. Pat. No. 4,155,191), the inventor discloses a lure with adjustable air content within the lure to advance different modes of buoyancy (from floating to diving) as described, albeit by different means, by Kechriotis (in U.S. Pat. No. 6,510,646) where the air containing device resides on the dorsal portion of the lure and is made to function as an “adjustable buoyancy device”. Yet, no patent designated above contains the capacity to change both weight and buoyancy through a single means, via adjustable weight and buoyancy attachments, that are the novel function and utility of the present invention.

Equally, albeit to a lesser extent, live bait enhancement also has received attention in recreational and commercial fishing in an attempt to garner the attention of predator fish. U.S. Pat. No. 5,386,661, issued to Davis, U.S. Pat. No. 6,038,806 issued to Maitland, and U.S. Pat. No. 2,825,174, issued to Leinonen, all evidence an improved method for placing a live bait fish upon a fish hook. Too, U.S. Pat. No. 4,067,135 issued to Martin discloses a revised fishing lure device “adapted to hold live, dead and artificial bait” serving the function of both live and artificial bait modification. Likewise, U.S. Pat. No. 6,993,866, issued to Strange, seeks to refashion the rig itself in an attempt to enhance the attractiveness, through sight, sound and smell, of live bait through additional attachments to a fishing bait rig. Yet, no attempt has been successful at enhancing a live bait fish in terms of additions or attachments that allows the angler to customize a live bait's aquatic profile and attractiveness to other predator fish.

Given the steps, skillfulness of manipulation and physical dexterity required to accomplish the above, it is manifestly untenable for all but the most adept angler to put forth the time, effort and skill required to perform the tasks required for lure augmentation and manipulation in the areas of visual configuration, visual attractiveness, sound production and both weight and buoyancy—either alone or in combination—prior to a fishing excursion with the available technology. What is more, the ability to modify artificial lures and live bait “in the field” requires exponentially greater adeptness at physical manipulation of not only the desired accessories to be utilized but also placement of these accessories into the anticipated recipient.

It is therefore the long-felt and unaddressed need of the ability of a fisherman to customize an artificial lure or live bait into any number of configurations, that the operator alone desires to create (based on changing conditions as much as proclivity), in an attempt to shape a lure or live bait into a uniquely designed and implemented fishing instrument. It is this need that the present invention seeks to address.

### SUMMARY OF THE INVENTION

The fishing lure and live bait augmentation device of the present invention provides a mechanism of artificial lure and live bait enhancement that is designed to allow for variable visual profiles, sound generation, alterable weight and buoyancy distribution together with placeable, replaceable and moveable hook attachment to an artificial lure and live bait in an expedient, ergonomic, and singularly, angler-specific customizable fashion. The present inventive device and method comprises an injection “gun” (a device most commonly employed in a retail clothing capacity) that is utilized to attach, via prepopulated or preloaded filamentous “tags”, one of a plurality of sonic balls, weights, and/or hooks. Conversely, the “tag” strands or “tags” may be configured and populated (self-populated) “in the field” to the exact specifications of each individual angler where one or any number of attachments may be selected on basis of desire or need and placed linearly on the filamentous “tag” strand. Operationally, the hand-held injector “gun” is stationary in relation to the lure and is made to advance a plastic T-bar tag into the lure body via a straight or curved injecting needle at any one of several points about the artificial lure or live bait. In one preferred embodiment, the curvature of the needle is a singularly defining element of the device in that this curvature is imperative for the functioning of the device to facilitate the actions of (1) needle and bar advancement, (2) bar implantation, and (3) unaccompanied needle egress relying upon the slightly askew insertion of the bar for successful bar retention and needle removal. Equally a straight needle can accomplish the aforementioned task where exact placement of the most proximal portion (to the point of injection) of the filamentous tag, the “T-bar”, requires direct insertion into a desired region. The T-bar “tag” itself is configured where the insertable bar is attached to a long, linear (loosely moveable) filamentous strand in a largely perpendicular configuration to the t-bar that allows for the filament strand to be pre-loaded (or selectively loaded) with any number and configuration of visual-sonic elements, fishing weights, buoyant spheres and/or hooks. This filament is then made to reside outside of the artificial lure or live bait for visual-sonic balls, weights, buoyant spheres and/or hook attachment and retention. The arrangement and tag may be varied and changed by any number of techniques, including, but not limited to, (1) cutting the filament length, (2) modifying the number and configuration of balls, weights, spheres and hooks, and (3) reproducing and moving the bar insertion points in several angler-desired points about the artificial lure or live bait as described in the method above. Yet, the usefulness, variability and configurability of the present invention is only curtailed by the angler and those having skill in the art. Too, a primary filamentous strand may be utilized to allow for the addition of other secondary filamentous “tag” strands along the primary strand's length to construct multiple branches emanating largely perpendicular to and from the stalk of the primary filamentous “tag” strand.

In one preferred embodiment, the above device and method gives the device operator a means to change the visual, sonic and weight and buoyancy profile of an artificial lure or live bait without lure or live bait removal from a fishing line. Correspondingly, these additions can result in any number of complex configurations and reconfigurations. Part and parcel with exterior augmentation, though, through various and varied attachments, the above device and method allows the operator/angler a means to adjust the laminar and turbulent flow of water around an artificial lure or live bait thereby effecting the profile of the artificial or live bait through the water and the particular tackle rigging's aquatic footprint as it travels through the water medium.

Too, another embodiment of the above device and method of accessory attachment allows the operator angler a means to position and reposition visual-sonic balls, weight and buoyancy spheres and fish hooks about and around the artificial lure or live bait by cutting or snipping unwanted filamentous tags and attaching new filamentous tags. Anglers may as well remove unwanted attachments and add wanted attachments by cutting the most terminal end of the strand and removing, moving and adding attachments and crimping, singeing or otherwise tying the most distal free “tag” end of the device. Likewise, the angler may simply shorten the overall length of the filamentous attachment by cutting and crimping or singeing the resultant open end.

In another embodiment, the above device and method allows the angler a means to either (1) use pre-loaded or pre-populated “tags” to change the arrangement and content of the filamentous tag or to (2) fill and attach the various above mentioned accoutrements to the direction of the operator's personal preference and desired configurations and arrangements in order to develop and adhere a singularly distinctive assemblage that meets both the requirements of changing fishing conditions and the selected predilection of the angler. By way of direction, the fisherman may (a) purchase a manufactured arrangement, (b) design and construct his or her own grouping or groupings prior to departure, or (c) assemble the desired organization of parts by loading the filamentous strand with selected accessories, crimping or tying the free end of the filamentous strand or soldering the free end on the filamentous tag (via a lighter or other means), and injecting the t-bar into the lure at any preferred insertion site about the lure or live bait “in the field”.

In yet another embodiment, primary t-bar tags may be made to accept along their filamentous length one or a plurality of secondary (additional) tags where the primary attached tag's original t-bar is substituted with a circular ring, or like attachment means, where the filamentous length of the primary t-bar tag receives the circular ring along its length and retains one or a plurality of secondary filamentous tags where such secondary tags are made to run largely perpendicular to the primary t-bar in placement and may be freely moveable along the length of the filamentous tag in the area abutted by other attachments as described above.

In yet another embodiment, pre-populated strands may be modifiable where the length or composition of a strand may be adjusted and modified by cutting the pre-populated strand to the desired length, re-populating or arranging a strand with desired attachments, or other pre-populated or self-populated strands, and crimping, tying or otherwise singeing the newly created open distal portion (e.g. via a lighter or other pyrotechnic source) into a closed terminus.

### BRIEF SUMMARY OF THE DRAWINGS

While the novel features and method of use of the application are set forth above, the application itself, as well as a preferred mode of use, and advantages thereof, will best be understood by referencing to the following detailed description when read in conjunction with the accompanying drawings in view of the appended claims, wherein:

FIG. 1 depicts the filamentous “tag” strand, t-bar and various attachments that make up the present invention.

FIG. 2 illustrates the affixing of the present invention to a lure.

FIG. 3 shows an injection gun for the attachment of the present invention to a lure or live bait fish.

FIG. 4 represents a version of the present invention that is a single filamentous “tag” strand.

FIG. 5 shows a primary filamentous “tag” strand harboring several secondary filamentous “tag” strands.

FIG. 6 is the present invention that is made to be adhered to a live bait fish.

And while the invention itself and method of use are amendable to various modifications and alternative configurations, specific embodiments thereof have been shown by way of example in the drawings and are herein described in adequate detail to inform those having skill in the art to make and practice the same. It should, however, be understood that the above description and preferred embodiments disclosed are not intended, and should not, limit the invention to the particular embodiment disclosed, but on the contrary, the invention disclosure is intended to cover all modifications, equivalents, and alternatives falling within the spirit and scope of the invention as defined within the claim's broadest reasonable interpretation consistent with the specification.

### DETAILED DESCRIPTION OF THE INVENTION

A detailed description of the preferred embodiments of the invention is disclosed and described below. Yet, each and every possible feature, within the limits of the specification, are not disclosed as every permutation is postulated to be in the purview and contemplation of those having skill in the art with the features herein described. It is therefore possible for those having skill in the art to accomplish the disclosed invention while observing that certain placement and spatial arrangements of relative and capable of being manipulated at various points about a lure or live bait that nonetheless accomplishes the remediation of one or more of the infirmities as outlined and discussed above in the field of both artificial and live-bait augmentation and modification.

Equally, it should be observed that the present invention can be understood, in terms of both structure and function, from the accompanying disclosure and claims taken in context with the associated drawings. And whereas the present invention and method of use are capable of several different embodiments, which can be arranged and rearranged into several configurations, which allows for mixing and matching of features and components, each exhibiting their accompanying interchanging functionalities, without departing from the scope and spirit of the present application.

The method of artificial lure and live bait modification and augmentation that is the present invention is depicted diagrammatically in the associated drawings. The disclosed invention and method of use relates to the attachment of an accessory-ladened, filamentous tag to an artificial lure or live bait wherein any number of configurable additions, in the form of beads, balls, weights or hooks, is arranged linearly or with in a plurality of secondary filamentous strands.

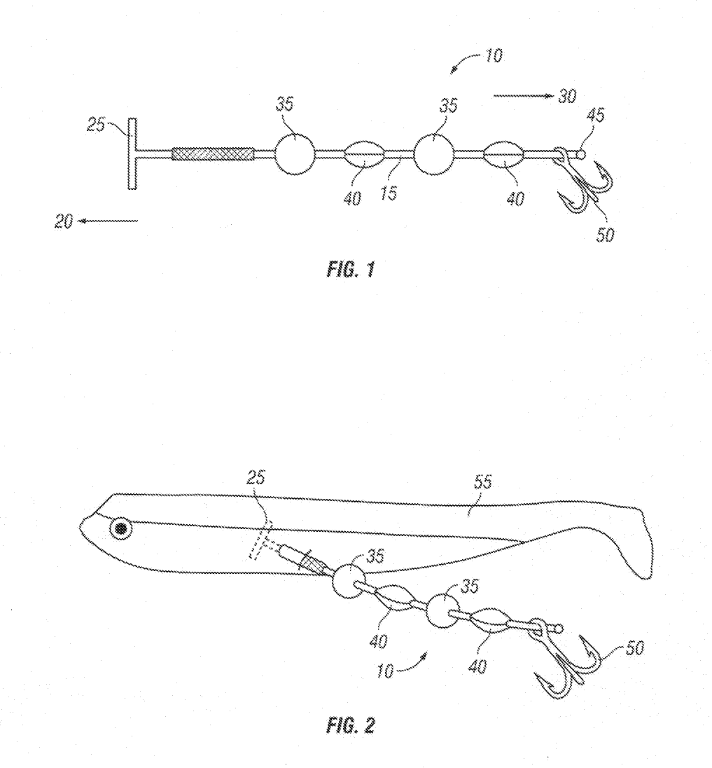

Referring now to the drawings wherein distinctive features are identified in FIG. 1 which illustrates the uninserted present device 10 that is comprised of a filamentous “tag” strand 15 that is abutted at the most proximal end 20 to the point of insertion by a perpendicularly running “T-bar” 25 which is designed for largely horizontal insertion into a surface upon advancement into a body which then releases into a 90 degree orientation upon insertion and release. Too several attachments are evidenced in FIG. 1 wherein sight and sound generating attachments 35, weight and buoyancy attachments 40 and hooks 50 may be attached to the filamentous strand 15 at any one of a number of possible positions. The most distal end 30 from the point of “T-bar” 25 insertion into an artificial lure or live-bait consists of a terminus 45 that blocks the rearward retreat of attachments 35, 40 and 50 and their release from the filamentous “tag” strand 15. This terminus 45 can be preapplied on a pre-populated filamentous strand or crimped, tied or singed in the case of an in-filed construction or adjustment.

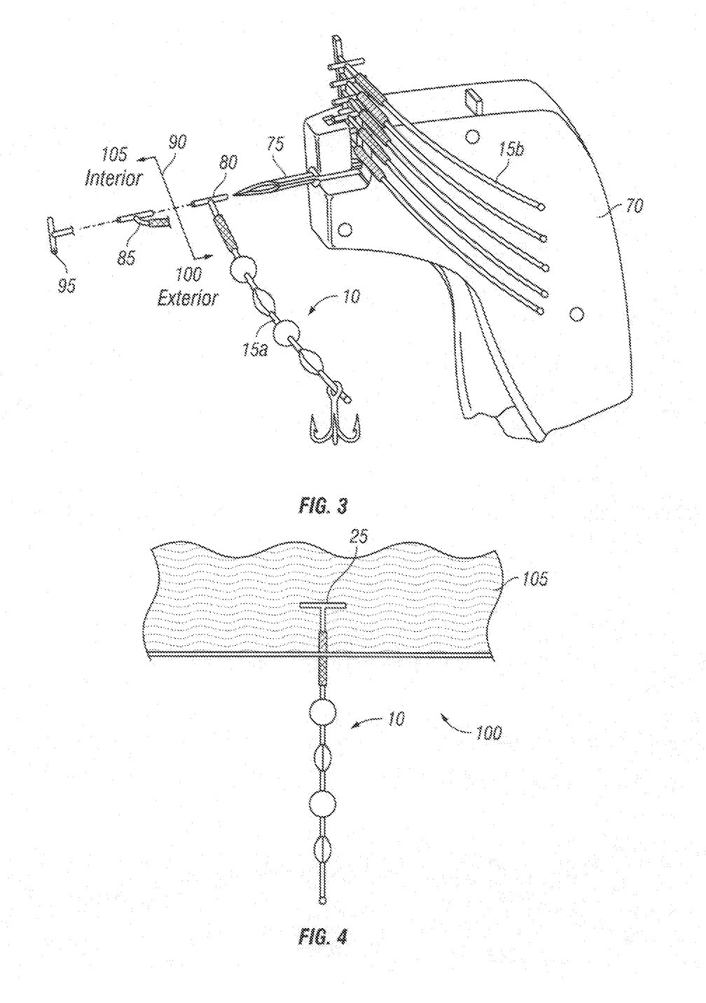

As seen in FIG. 2, the perpendicularly running “T-bar” 25 is inserted into the soft body of an artificial lure 55 at a lateral area, but could be as easily inserted at any area about the artificial lure 55 that will support device 10 insertion. Further, sight and sound generating attachments 35, weight and buoyancy attachments 40 and hooks 50 may be attached to the filamentous strand 15 at any one of a number of possible positions where the various attachments may exist as any one of many combinations, situated more proximal 20 to the point of insertion, more distal 30 to the point of insertion (as depicted in FIG. 1) and be composed of several like and unlike of groupings of attachments. And while sight and sound generating devices 35 in FIG. 2 can be seen to be separated by buoyancy attachments 40 with a terminating hook 50, the arrangement can enjoy any one of a number of configurations where the filamentous strand 15 could be populated by all sight and sound generating attachments 35, all weight and buoyancy attachments 40, all hooks 50 or a combination thereof.

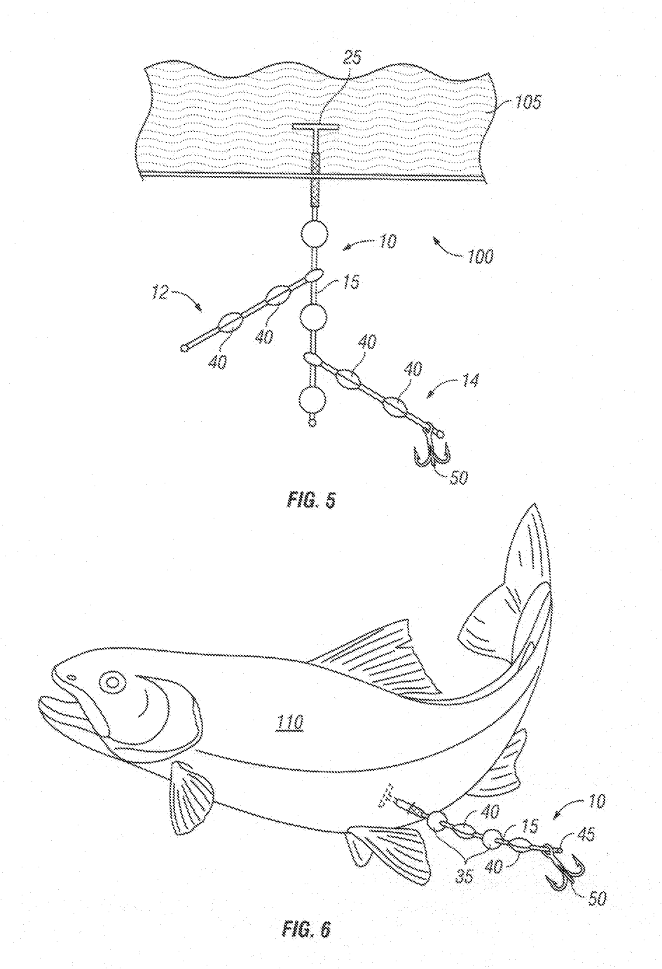

Referring now to FIG. 3, an injection gun 70 is shown where a pre-populated filamentous strand 15a of device 10 is made to be advanced via an injecting needle 75 that “injects a “T-bar” 25 expressing a perpendicular confirmation 80 prior to insertion into a body 90, which encompasses a largely horizontal confirmation 85 through the insertion process and in a second perpendicular confirmation 95 post insertion which functions to maintain device 10 adherence into a body 90 from the exterior of the body 100 to the interior of the body 105. As depicted, FIG. 3 further evidences filamentous strands 15b that may either be pre-populated or readily customizable.

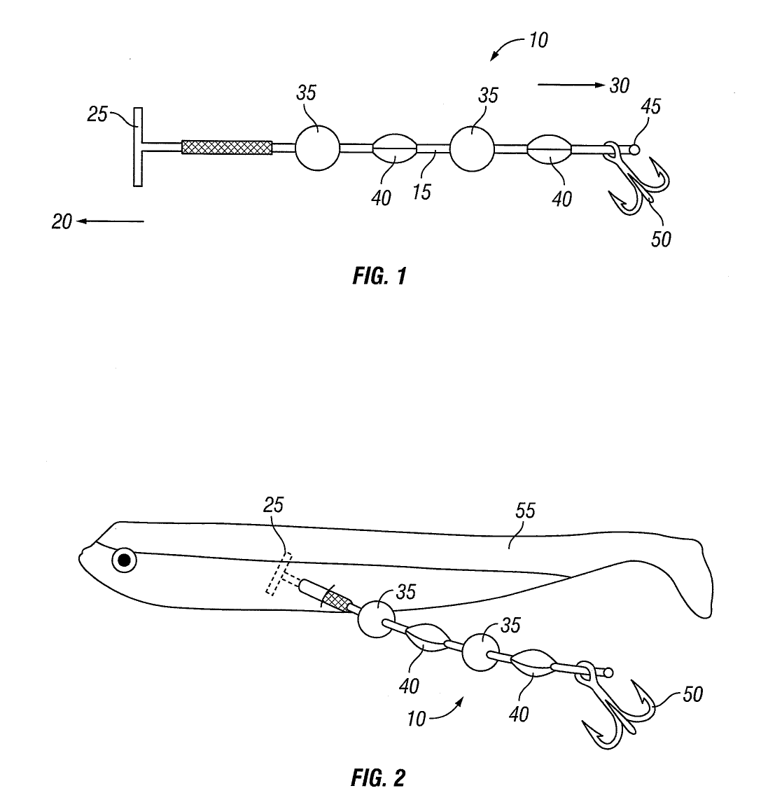

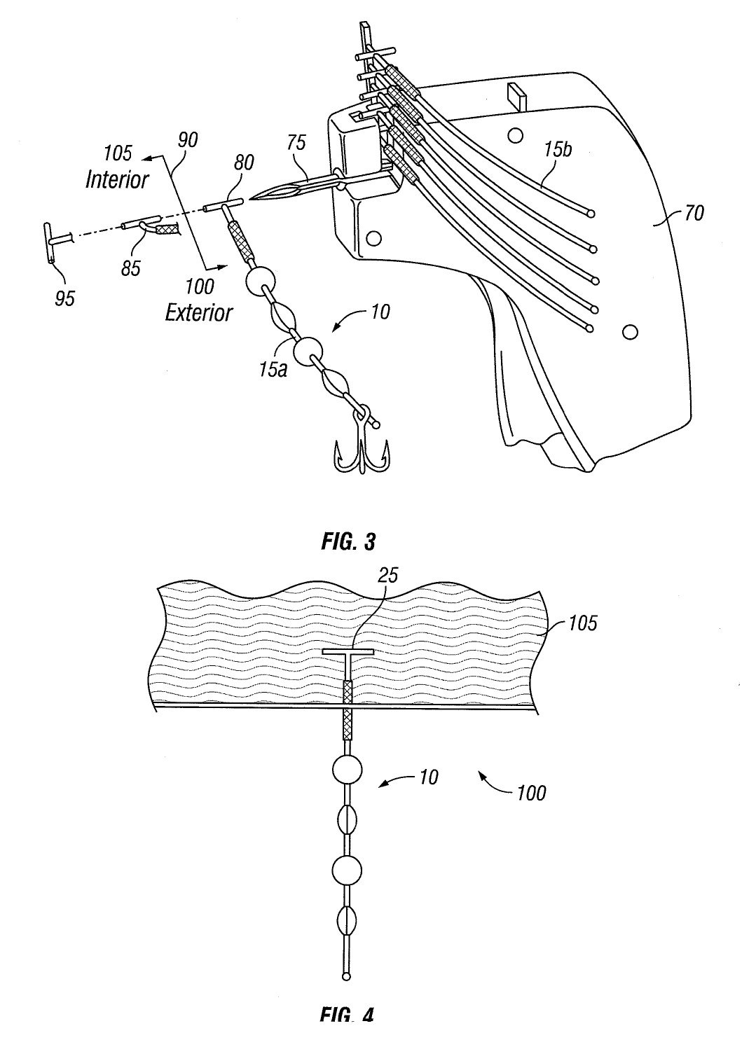

Referring now to FIGS. 4 and 5, FIG. 4 depicts one embodiment of a pre-populated or customized single device 10 wherein the perpendicularly running “T-bar” 25 is inserted into the interior 105 of the body (as depicted in FIG. 3) and the filamentous strand 15 remains exterior 100 to the body 100 while attached to an artificial lure or live bait. FIG. 5 shows yet another embodiment where secondary device 12 is illustrated to add weight attachments 40 to a primary device 10 via secondary device 12 and weight attachments 40 and a hook 50 are shown to attach to a primary device 10 via a branching secondary device 14. Of note, too, is that this is but one configuration and can be readily modified prior to lure or bait use or structured and restructured contemporaneously “in the field”.

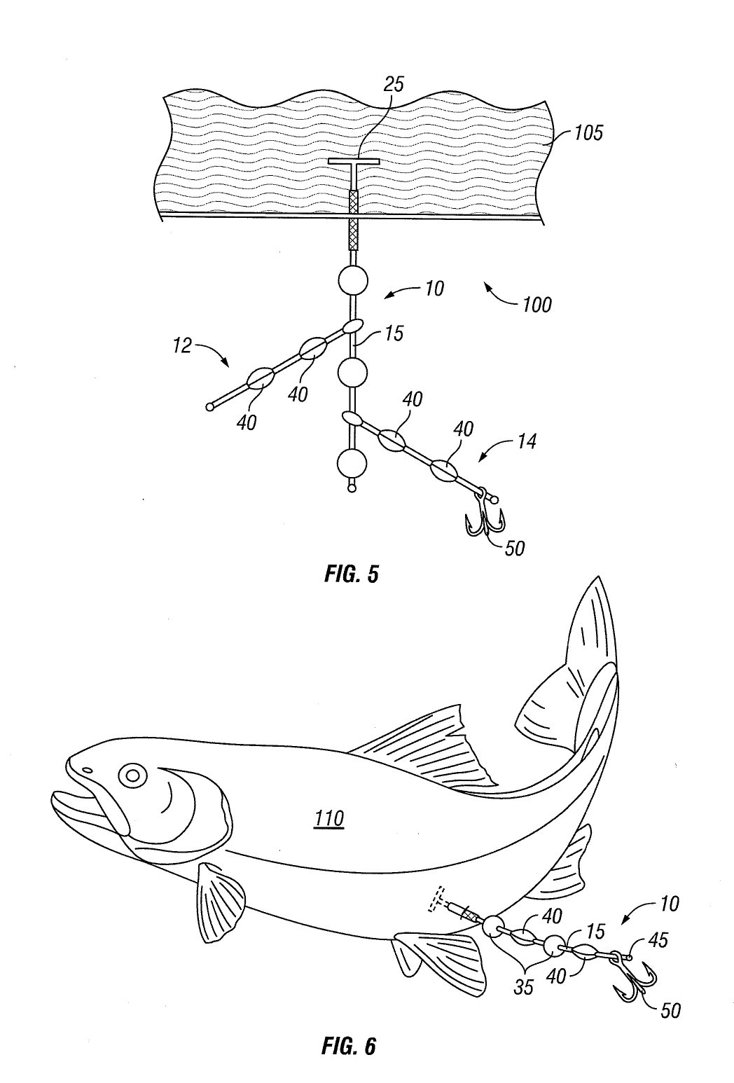

As seen in FIG. 6, a primary device 10 is attached to a live bait 110 which is made to exhibit sight and sound generating attachments 35 alternating with weight and buoyancy attachments 40 and terminal hook 50, from most proximal end 20 to the point of insertion to the most distal end 30 to the point of insertion, which ends with terminus 45 that blocks the rearward retreat of attachments 35, 40 and 50 and thwarts their release from filamentous strand 15.

The present invention evidences many advantages over the prior art including at least the following: (1) the ability to modify artificial lures and bait fish, alike, (2) in a premeditated or contemporaneous and time efficient manner that is (3) angler specific (4) situational specific and (5) encompassing the ability to provide for any number of arrangements, linearly and perpendicularly situated, as per each angler's proclivity.

The particular embodiments disclosed are merely illustrative, which may be apparent to those having skill in the art that may be modified in diverse but equivalent manners. It is therefore contemplated that these particular embodiments may be altered and modified and that all such alterations are considered within the scope and spirit of the present application. And while these illustrations are of a limited number set, it is clear that the invention itself is mutable to any number of arrangements, configurations and modifications without departing from the invention's spirit thereof.

We claim:

1. A method of artificial soft lure and live bait modification and augmentation, through attachment of various forms of accessories via a device comprising a filamentous strand and abutting T-bar and terminus, through a precise point of insertion wherein:
a filamentous strand, in the form of a tag, is composed of a proximal T-bar, a filamentous strand and distal terminus marked by a circumference and diameter that is greater than that of the filamentous strand that is entered into an injection device via said proximal T-bar;
said filamentous tag is translocated from said insertion device into an artificial lure soft-body or live bait via the T-bar actuated to configure into a largely horizontal configuration during insertion and a perpendicular conformation both before and after insertion;
said horizontal configuration aiding in linear penetration into said soft body or live-bait;
said perpendicular configuration assisting in both loading and insertion of device and adherence within said soft body post injection.

2. The method of claim 1, wherein said proximal T-bar is made of a malleable material that is capable of distortion to a largely horizontal configuration and back to a largely perpendicular configuration both before and after device insertion.

3. The method of claim 1, wherein said horizontal filamentous strand may be plastic, wire, thread or a combination thereof which is capable of accepting various attachments.

4. The method of claim 1, wherein said filamentous strand is populated with discretely shaped, sized and colored attachments for the augmentation of said soft-body artificial lure or live bait which may be populated by attachments intended to change the shape, color, visual recognition, reflectivity, audible sound projection, weight and buoyancy conformations of said artificial lure and live bait.

5. The method of claim 1, wherein said filamentous strand may be additionally populated by the attachment of a hook or plurality of hooks at various positions along the filamentous strand.

6. The method of claim 1, wherein said attachments may be configured in any manner of sequences, be it heterogeneous, homogeneous, alternating or randomly displayed.

7. The method of claim 1, wherein said filamentous strand may be pre-populated to a predetermined set of attachments, including attachments intended to change the shape, color, visual recognition, reflectivity, audible sound projection, weight and buoyancy conformations of said artificial lure and live bait bodies and attachments, such as a hook or plurality of hooks, that may be attached at any point exterior to said bodies and along the length of said filamentous strand.

8. The method of claim 1, wherein said attachments may be configurable and self-populated by the angler, in the field, to match desired conformations due to changes in environment, conditions and angler preferences, with reference of desired effects, wherein attachments may be selected before use and need or contemporaneous with changing conditions or desires to match the preferred changes in artificial lure and live bait appearance.

9. The method of claim 1, wherein a filamentous strand may be made to harbor other, secondary filamentous strands wherein the proximal T-bar is replaced by a circular means for attaching to the length of the primary filamentous strand to accomplish “branching” of secondary filamentous strands, equally configurable and capable of pre-population, customization or both.

10. The method of claim 1, wherein one filamentous strand may replace existing filamentous strands where existing strands are removed and new strands are adhered.

11. The method of claim 1, wherein where attachments may be configurable and modified by the angler in the field where said filamentous strand or strands may be constructed prior to use, in the case of a pre-populated filamentous strand or strands, or modified and subsequently crimped, tied or singed in the case of a modifiable construction or adjustment where pre-constructed strands are equally modifiable in the field.

12. The method of claim 1, wherein newly introduced strands may augment existing filamentous strands where both self-populated stands and pre-populated stands, alike, can be cut and rearranged or re-populated with the same or different attachments up to and including other pre-populated or self-populated strands followed by the reconstruction of a terminus through tying, crimping or singeing.

13. The method of claim 1, wherein said injection device is an injection gun for the injection of the T-bar into a body.

14. The method of claim 1, wherein the injection device is a gun and may inject into said bodies one to a plurality of pre-populated and angler customizable filamentous strands individually or via primary self-populated or pre-populated strands or primary populated or pre-populated strands that harbor secondary self-populated or pre-populated strands.

15. An artificial soft lure and live bait modification and augmentation device for attachment through a precise point of insertion accessories via a filamentous, exteriorly residing strand comprising:
a filamentous strand;
a T-bar abutting said filamentous at a point most proximal to the point of device insertion into a body;
a terminus residing at a point most distal to the point of device insertion into a body;
a series of attachments designed to change the shape, color, visual recognition, reflectivity, audible sound projection, weight and buoyancy conformations of a body;
a hook or plurality of hooks; and
an insertion gun.

16. The device of claim 15, wherein said T-bar is made to reside interior to a body and the filamentous strand and terminus are made to reside exterior to a body that is a soft body artificial lure or a live bait.

17. The device of claim 15, wherein said T-bar is of a malleable material as is required for a largely horizontal configuration upon insertion and resilience to a largely perpendicular confirmation both before and after insertion and filamentous strand of a material that allows for a flexibility in use.

18. The device of claim 15, wherein said insertion gun utilizes an accepting, hollow needle for the loading and insertion of said T-bar into said body.

19. The device of claim 15, wherein said filamentous strand is made to accept attachments in of various sizes, shapes, colors, reflectivity profile, in ordered and unordered combinations, up to and including weights, buoyancy attachments, laminar-turbulent and sound generating attachments and visually stimulating attachments which may include a hook or a plurality of hooks.

20. The device of claim 15, wherein the filamentous strand may be pre-populated or angler populated with attachments and/or other pre-populated or angler-populated attachment accepting filamentous strands both prior to use or contemporaneous with desired or required change.
